(19) United States
(12) Patent Application Publication
(10) Pub. No.: US 2025/0332455 A1
(43) Pub. Date: Oct. 30, 2025

(54) Low Input Pressure Lung Demand Valve

(71) Applicant: Dräger Safety AG & Co. KGaA, Lübeck (DE)

(72) Inventor: Iain Brechtelsbauer, Whitley Bay (GB)

(21) Appl. No.: 19/187,054

(22) Filed: Apr. 23, 2025

(30) Foreign Application Priority Data
Apr. 26, 2024 (EP) 24172823.7

(51) Int. Cl. A62B 9/02

(52) U.S. Cl. CPC A62B 9/022

(57) ABSTRACT

A demand regulator for a breathing apparatus may include a primary lever arm can include a cam element having a first profile and a second profile, the primary lever arm being pivotable; and a valve configured to regulate a flow of breathing gas through the demand regulator. The valve may include a valve member being displaceable so as to regulate the flow of breathing gas. The cam element of the primary lever arm is configured to displace the valve member during pivoting of the primary lever arm. Pivoting of the primary lever arm through a first arc displaces the valve member at a first displacement rate; and pivoting of the primary lever arm through a second arc displaces the valve member at a second displacement rate. A breathing apparatus can include a demand regulator and a diaphragm-actuated lever arm. A method for designing a cam element profile is disclosed.

### CROSS-REFERENCE TO RELATED APPLICATIONS

This application claims priority to European Patent Application No. 24172823.7 filed on Apr. 26, 2024, and titled “Low Input Pressure Lung Demand Valve,” which is hereby incorporated by reference in its entirety for all nonlimiting purposes.

This disclosure relates to lung demand regulators and, more specifically to lung demand regulators for breathing apparatus.

### BACKGROUND

Self-contained breathing apparatus (SCBA) generally comprise a lung demand regulator (also referred to as LDR, ‘demand regulator’, or ‘regulator’) and face mask. The LDR is connected to the face mask to provide a user with breathable air on demand. SCBA systems are often used by factory workers or emergency service personnel such as firefighters, and are therefore often exposed to environments containing harmful contaminants such as smoke or toxic chemicals. Typically, an LDR used in a SCBA will be configured in a “positive pressure” mode to prevent any environmental contaminants from entering the SCBA system.

In certain situations, the pressure of breathing gas being supplied to an LDR may fluctuate. For example, the pressure in a pressurised gas distribution system (e.g., a ring main) in a factory may fluctuate according to the position in the system and the demand of each node in the system, or the pressure of gas provided from a breathing gas cylinder may gradually drop as the cylinder is gradually depleted. When the pressure of breathing gas entering the LDR drops below a prescribed level, the pressure inside the face mask is at risk of becoming negative relative to the ambient air pressure. A negative face mask pressure puts the user of the SCBA at risk as environmental contaminants can be drawn into the face mask. Therefore, it will be understood that improvements to existing LDR designs are desirable.

### SUMMARY

In a first aspect, there is provided a demand regulator for a breathing apparatus comprising: a primary lever arm comprising a cam element having a first profile and a second profile, the primary lever arm being pivotable; and a valve configured to regulate a flow of breathing gas through the demand regulator, the valve comprising a valve member being displaceable so as to regulate the flow of breathing gas; wherein the cam element of the primary lever arm is configured to displace the valve member during pivoting of the primary lever arm; and wherein: pivoting of the primary lever arm through a first arc corresponding to the first profile of the cam element displaces the valve member at a first displacement rate; and pivoting of the primary lever arm through a second arc corresponding to the second profile of the cam element displaces the valve member at a second displacement rate; the second displacement rate being different to the first displacement rate. The second displacement rate may be higher than the first displacement rate.

Pivoting the primary lever arm through a first arc corresponding to the first profile of the cam element will be understood to mean that during rotation of the primary lever arm through the first arc, the first profile of the cam element causes the displacement of the valve member. Equally, pivoting the primary lever arm through a second arc corresponding to the second profile of the cam element will be understood to mean that during rotation of the primary lever arm through the second arc, the second profile of the cam element causes the displacement of the valve member.

It will be understood that the valve member may act as a cam follower to follow the first and second profiles of the cam element during rotation or pivoting of the primary lever arm. Alternatively, a linkage may be provided to transmit movement of a cam follower to the valve member. The linkage may be a secondary lever arm comprising a cam follower. Pivoting of the primary lever arm in a first direction (e.g., anticlockwise) may pivot the secondary lever arm in the opposing direction (e.g., clockwise). The cam element of the primary lever arm may contact the secondary lever arm.

It will be understood that the valve member may be in communication with the cam element. The valve member may be in direct or indirect contact with the cam element. The valve may further comprise a piston in communication with the valve member. The piston may be disposed between the valve member and the primary lever arm, or (where a secondary lever arm is provided) between the valve member and the secondary lever arm. References to ‘indirect contact’ may refer one component being engaged with but otherwise not in physical contact with another component. For example, the valve member being in indirect contact with the cam element may mean that the valve member is linked to and/or can be engaged by the cam element, without being in physical contact

During pivoting of the primary lever arm, the valve member may be displaced in a direction radial to a rotational axis of the primary lever arm. The magnitude of the displacement may correspond to an effective radial thickness of the cam element at a point where the cam element is linked to the valve member.

The displacement rate may be a rate of change of displacement of the valve member relative to the rate of pivoting of the primary lever arm. A rate of pivoting of the primary lever arm may be considered to be an angular velocity of the primary lever arm. The displacement rate may be constant (i.e., linear) across each of the respective profiles of the cam element or may itself change with the rotation of the primary lever arm.

The valve member may be configured to form an airtight seal against a seal seat comprised in the valve when the valve member is in a minimum displacement state.

Pivoting of the primary lever arm through the first arc may correspond to a pivoting of the primary lever arm between a first rotation angle and a second rotation angle of the primary lever arm; and pivoting of the primary lever arm through the second arc may correspond to a pivoting of the primary lever arm between a third rotation angle and a fourth rotation angle of the primary lever arm.

Each of the first to fourth rotation angles may be measured around a rotational axis of the primary lever arm. Each of the second to fourth rotation angles may be measured from a first position of a longitudinal axis of the primary lever arm. The first position may correspond to the first rotation angle. The first rotation angle may be set at zero degrees (i.e., an initial position of the primary lever arm). Each of the first to fourth rotation angles may be different Each of the first to fourth rotation angles may be of increasing magnitude. The second and third rotation angles may be equal.

It will be understood that pivoting the primary lever arm through the first arc means pivoting the primary lever arm from the first rotation angle to the second rotation angle (or vice versa). It will be understood that pivoting the primary lever arm through the second arc means pivoting the primary lever arm from the third rotation angle to the fourth rotation angle (or vice versa).

It will be appreciated that, during pivoting of the primary lever arm through the first arc, the valve member is in communication with the first profile of the cam element to thereby cause displacement of the valve member according to the first profile. It will be appreciated that, during pivoting of the primary lever arm through the second arc, the valve member is in communication with the second profile of the cam element to thereby cause displacement of the valve member according to the second profile.

The primary lever arm may be configured to pivot through the first arc when an input breathing gas to the demand regulator is above a threshold pressure. The primary lever arm may be configured to pivot through the second arc when the input breathing gas to the demand regulator is below the threshold pressure.

Configured to pivot through the first arc shall be understood to mean that, when the input breathing gas is at a pressure above the threshold pressure, the primary lever arm is able to pivot to and/or between any point or points on the first arc. Configured to pivot through the second arc shall be understood to mean that, when the input breathing gas is at a pressure below the threshold pressure, the primary lever arm is able to pivot to and/or between any point or points on both the first arc and the second arc.

When the input breathing gas is at a pressure above the threshold pressure, the first profile of the cam element (which corresponds to the first arc through which the primary lever arm pivots) may displace the valve member during pivoting of the primary lever arm through the first arc. When the input breathing gas is at a pressure below the threshold pressure, the second profile of the cam element (which corresponds to the second arc through which the primary lever arm pivots) may displace the valve member during pivoting of the primary lever arm through the second arc. The threshold pressure may be between 300 kPa and 600 kPa, optionally between 400 kPa and 500 kPa, further optionally may be 450 kPa.

References herein to “above” and “below” a threshold may include “at or above” and “at or below” a threshold, respectively.

The first and second profiles may be convex. The first profile may be arcuate with a first radius and the second profile may be arcuate with a second radius. The first radius may be different to the second radius.

Arcuate will be understood to mean a portion of a circumference of a circle. Therefore, it will be understood that the first and second cam profiles may each take the shape of a portion of a circumference of a circle, each with a given first and second radius. The first and second radii may be the same or different. The first radius may be larger than the second radius. The first radius may be smaller than the second radius.

The first profile and the second profile may meet at a transition point. The transition point may be a continuous or discontinuous transition point. A transition point may be a smooth/continuous transition point between the first profile and the second profile. A transition point may be a discontinuous transition point.

The demand regulator may further comprise a secondary lever arm disposed between the cam element and the valve member. The secondary lever arm may be configured to transmit movement of the cam element to the valve member. The secondary lever arm may be an adjustable lever arm configured to adjustably vary a proportion of the movement transmitted from the cam element to the valve member. The adjustable lever arm may comprise a setting screw.

A setting screw may vary an effective thickness of the adjustable lever arm. Adjusting the effective thickness of the adjustable lever arm may apply a displacement offset to the displacement transferred from the cam element to the valve member. The setting screw may or may not be accessible from the outside of the demand regulator. The setting screw may or may not be intended to be accessed and/or configured by a user.

The demand regulator may further comprise a body defining and internal cavity; and a diaphragm disposed in the body. The diaphragm may be in communication with the internal cavity on a first side and may be in communication with an ambient environment on a second side. The primary lever arm may be configured to abut or otherwise contact the diaphragm. A pressure decreases in the internal cavity may cause the diaphragm to flex towards the internal cavity, thereby pivoting the primary lever arm. The diaphragm may be configured to be flexed towards and/or away from the internal cavity depending on a pressure differential across the diaphragm. A pressure differential across the diaphragm will be understood to mean a difference in pressure between the first and second sides of the diaphragm.

It will be understood that when breathing gas at a pressure greater than the ambient environment is introduced into the demand regulator, a pressure differential across the diaphragm may be formed. The pressure differential may correspond to the input breathing gas pressure. A higher input or lower breathing gas pressure may correspond to a higher or lower pressure differential, respectively.

It will be understood that the pressure differential may correspond (at least in part) to the extent to which the diaphragm is urged towards and/or away from the internal cavity. When the pressure differential across the diaphragm is higher, a decrease in pressure resulting from a user of the demand regulating inhaling may result in a smaller movement of the diaphragm towards the internal cavity then when the pressure differential across the diaphragm is lower. The body may house the valve member. The body may house the secondary lever. The diaphragm may be an adjustable diaphragm, wherein the extent to which the diaphragm is urged towards the internal cavity by a pressure decrease is adjustable.

In a second aspect, there is provided a breathing apparatus comprising a demand regulator according to the first aspect. A breathing apparatus may comprise a face mask, a breathing gas tank, a first stage breathing circuit, a second stage breathing circuit, and/or one or more pressure regulators.

In a third aspect, there is provided a diaphragm-actuated lever arm for a demand regulator comprising: a cam element for displacing a valve of the demand regulator, the cam element comprising a first cam profile and a second cam profile; and a diaphragm contact portion, configured to transfer movement of a diaphragm to the diaphragm-actuated lever arm, thereby causing the diaphragm-actuated lever arm to pivot; wherein: pivoting of the lever arm through a first arc corresponding to the first cam profile is configured to displace the valve at a first displacement rate; and pivoting of the lever arm through a second arc corresponding to the second cam profile is configured to displace the valve at a second displacement rate, different to the first displacement rate.

The diaphragm-actuated lever arm may comprise a pivot at a proximal end. The diaphragm contact portion may be at a distal end of the diaphragm-actuated lever arm. The diaphragm contact portion may rest against the diaphragm. The diaphragm contact portion may be a foot of the diaphragm-actuated lever arm. The diaphragm contact portion may cause the diaphragm-actuated lever arm to rotate around the pivot according to a movement of the diaphragm. The cam element may be proximate to the pivot. The cam element may be disposed between the pivot and the diaphragm contact portion.

In a fourth aspect, there is provided a method for designing a cam element profile for a lever arm of a demand regulator, the demand regulator comprising a valve member, the cam element profile being configured to displace the valve member, the method comprising the steps of: determining a first peak breathing gas flow rate across a plurality of different valve member displacements at a first breathing gas input pressure, thereby determining a first flow-displacement profile; determining a first minimum desired peak flow rate at the first breathing gas input pressure; determining a first minimum valve displacement that provides the first minimum desired peak flow rate based upon the first flow-displacement profile; and determining a first cam profile, comprised in the cam element profile, that displaces the valve member to at least the first minimum valve displacement across an entirety of a first pivot arc of the lever arm. The method may be a computer-implemented method. The method may further comprise manufacturing a lever arm comprising the determined cam element profile. The method may further comprise outputting data comprising a 3D design model comprising the determined cam element profile, for example a CAD model, an additive manufacturing model, and/or additive manufacturing instructions. The 3D design model may comprise data indicating the determined cam element profile or a lever arm comprising the determined cam element profile.

The method may be repeated one or more times. Where the method is repeated, the cam element profile designed in the preceding occurrence of the method may be used to determine the first flow-displacement profile during a subsequent occurrence of the method, the minimum desired peak flow rate, and/or the minimum valve displacement. In this way, the design of the cam element profile may iteratively be improved and/or optimised.

The method may further comprise the steps of: determining a second peak breathing gas flow rate across the plurality of different valve member displacements at a second breathing gas input pressure, thereby determining a second flow-displacement profile; determining a second minimum desired peak flow rate at the second breathing gas input pressure; determining a second minimum valve displacement that provides the second minimum desired peak flow rate based upon the second flow-displacement profile; and determining a second cam profile, comprised in the cam element profile, that displaces the valve member to at least the second minimum valve displacement across the entirety of a second pivot arc of the lever arm.

### BRIEF DESCRIPTION OF THE DRAWINGS

Arrangements of the disclosure will now be described, by way of example, and with reference to the accompanying drawings, in which:

FIG. 1 shows a schematic view of a breathing apparatus according to an example arrangement comprising a breathing mask and demand regulator;

FIG. 2 shows a schematic view of a face mask connected to a demand regulator according to the present disclosure;

FIG. 3 shows a cross sectional view of the demand regulator shown in FIG. 2 (marked A-A);

FIGS. 4A-B show one embodiment of a primary lever arm according to the present disclosure in different pivot positions;

FIG. 5A-C show further embodiments of a primary lever arm according to the present disclosure; and

FIG. 6 shows a block diagram of the method according to the present disclosure.

### DETAILED DESCRIPTION OF THE DRAWINGS

As discussed above, existing regulator are susceptible to performance degradation and increased safety risk when subjected to lower breathing gas input pressures. When a regulator receives lower pressure breathing gas, there is a greater likelihood that inhalation by the user will cause a period of negative (i.e., lower than ambient) pressure inside the regulator and/or face mask. This negative pressure increases the risk of harmful environmental contaminants being drawn into the regulator and/or face mask-putting the user at risk.

Lower breathing gas input pressure generally means breathing gas at pressures lower than a typical or ‘design’ breathing gas input pressure. In other words, lower breathing gas input pressure may represent a pressure of breathing gas lower than that with which a demand regulator is designed to operate during normal use.

Until now, few solutions have been offered which attempt overcome these drawbacks. Notably, U.S. Pat. No. 6,729,331 B2 appears to disclose a pressure regulator comprising a diaphragm, the biasing of which can be adjusted via a load spring and knob. By adjusting the biasing of the diaphragm, the pressure regulator may be adapted to account for lower input breathing gas pressures while maintaining positive pressure inside the regulator. However, this regulator exhibits a number of significant limitations. Firstly, the load spring must be adjusted manually by the user. Such adjustment requires precise motor movements which are difficult if not impossible to achieve when wearing thick gloves and when undertaking strenuous activity. Further, the user must divert their attention to carefully adjust the knob at the correct time to ensure their safety. In critical situation (for example when the user is a firefighter responding to an emergency), it is likely to be unsafe for the user to divert their attention from the task in hand in this way. Indeed, even if the user is able to divert their attention, they must do so at precisely the right time to ensure that the biasing of the diaphragm closely corresponds to the input breathing gas pressure. Otherwise, the user risks exposing themself to harmful environmental contaminants.

Secondly, the load spring and knob introduce additional points where manufacturing tolerances and variations can considerably impact the performance of the regulator. Even small differences in the dimensions of the load spring and/or knob could have a significant impact on the accuracy of any adjustment control the user has. These additional components are also likely to be affected unpredictably by the environment in which the regulator is used. In particular, the biasing provided by the load spring is likely to be altered by environmental temperature variations, independent of any adjustments made by the user-leading to further risks to the user's health.

As will be described shortly through various exemplary embodiments, the present disclosure provides improvements over known pressure regulators.

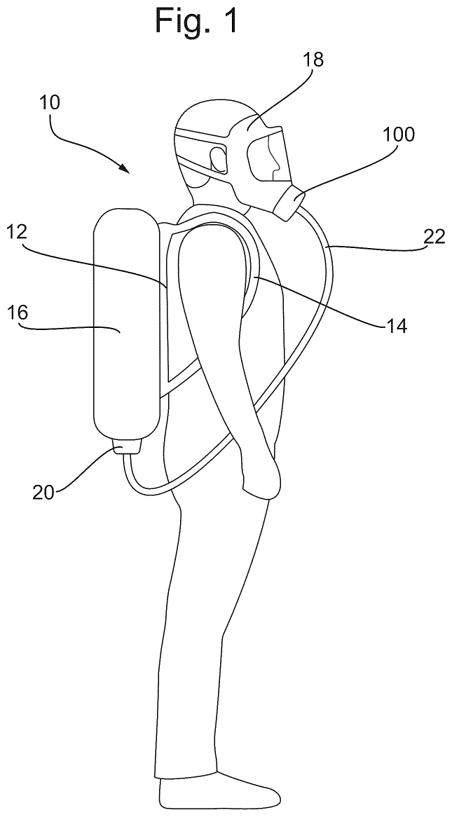

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a face mask 18, a lung demand regulator 100 connectable to the face mask 18, and a pneumatics system 20 for delivering breathing gas from the cylinder 16 via a hose or flexible conduit 22 to the lung demand regulator 100, to thereby deliver breathing gas to the user wearing the face mask 18 on demand. The breathing apparatus 10 may further comprise other components or systems which are not shown, including but not limited to an electrical system, a monitoring system, or a communications system. The lung demand regulator 100 is referred to as the regulator 100 throughout.

In this illustrated arrangement, the breathing apparatus 10 is a self-contained breathing apparatus (SCBA), but it should be understood that the lung demand regulator may also have applications in other types of breathing apparatus, such as self-contained underwater breathing apparatus (SCUBA) and emergency escape breathing apparatus.

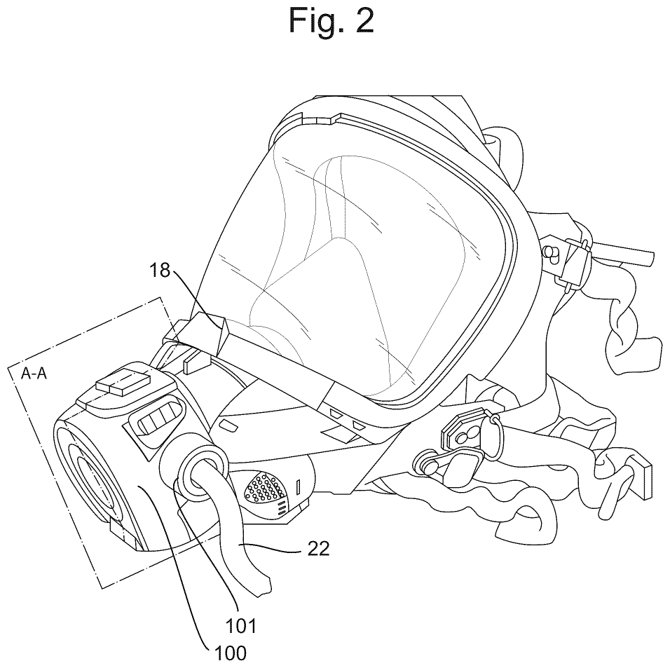

Turning to FIG. 2, a schematic view of a face mask 18 attached to the regulator 100 is shown. A hose 22 of the pneumatics system 20 is connected to an inlet 101 of the regulator 100 to provide breathing gas from the cylinder 16. The pneumatics system 20 may comprise a first-stage pressure reducer which reduces the pressure of the breathing air from the cylinder which may be stored at several hundred bar, to an intermediate pressure for provision to the regulator 100 via the hose 22. The intermediate pressure may be too high for the breathing gas to be provided directly to the user to breathe. The regulator 100 may further comprise a second-stage pressure reducer which further reduces the pressure of the breathing gas to a suitable pressure for delivery to the user to breathe. In other arrangements, more than two or fewer than two pressure reducers may be provided. In some arrangements, the regulator 100 is connected to a pressurised breathing gas circuit for workers to use, such as in a factory. In this case, the breathing gas may be provided by the circuit at a breathable pressure and so a pressure reducer may not be required.

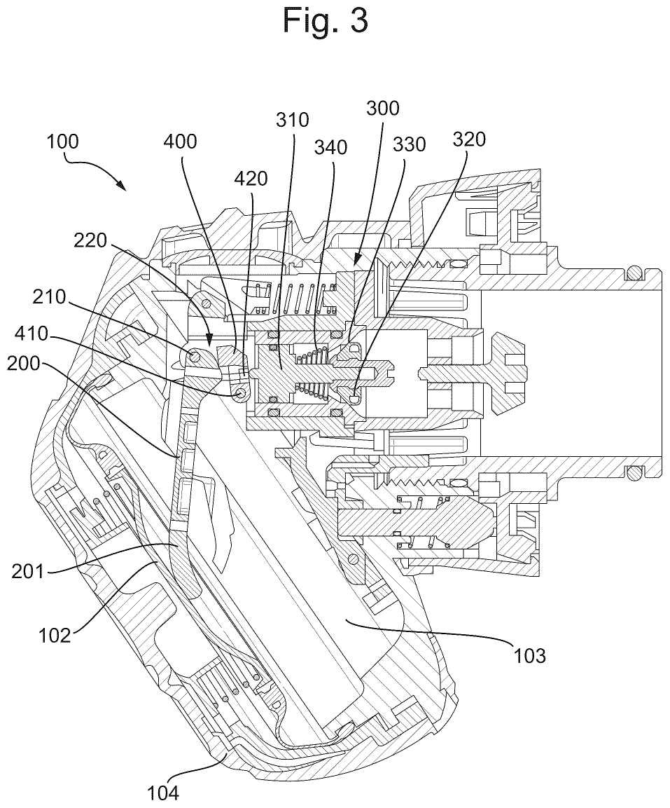

FIG. 3 shows a cross sectional view of the regulator 100, marked as ‘A-A’ in FIG. 2. The regulator 100 comprises a body 104, a diaphragm 102, a primary lever arm 200, and a valve 300. In the illustrated embodiment, the diaphragm 102 is a thin, flexible, impermeable membrane which is secured to the body 104. On one side, the diaphragm 102 is exposed to the ambient environment and therefore the ambient air pressure. On the other side, the diaphragm 102 is exposed to an internal cavity 103 formed in the body 104 of the regulator 100.

As the diaphragm 102 is formed of a flexible material, any difference in the ambient air pressure and the pressure of the internal cavity 103 causes the diaphragm 102 to flex. When the ambient pressure is greater than the internal cavity 103 pressure, the diaphragm 102 flexes inwards, towards the internal cavity 103. When the ambient pressure is less than the internal cavity 103 pressure, the diaphragm 102 flexes outwards, away from the internal cavity 103. The greater the difference between the ambient and internal cavity 103 pressures the greater the flexing of the diaphragm 102.

The primary lever arm 200 comprises a pivot point 210 about which the primary lever arm 200 is pivotable. The primary lever arm 200 is in communication with the valve 300 and pivoting of the primary lever arm 200 actuates the valve 300 (as will be described in more detail later), thereby controlling the introduction of pressurised breathing gas into the internal cavity 103. The primary lever arm 200 further comprises a foot 201 at an end of the primary lever arm 200 distal from the pivot point 210. The foot 201 contacts the diaphragm 102. In the illustrated embodiment, the foot 201 contacts a substantially central portion of the diaphragm 102. The foot 201 may be positioned at an angle relative to the primary lever arm 200. When the diaphragm 102 flexes inwards towards the internal cavity 103, the diaphragm 102 pushes on the foot 201, causing the primary lever arm 200 to pivot about the pivot point 210.

According to the view shown in FIG. 3, the primary lever arm 200 pivots anticlockwise about the pivot point 210 as the diaphragm 102 flexes inwards. It will be appreciated that the extent to which the primary lever arm 200 pivots about the pivot point 210 corresponds to the extent to which the diaphragm 102 flexes inwards. Therefore, when the ambient air pressure is significantly greater than the pressure in the internal cavity 103, the diaphragm 102 will flex inwards significantly, causing a significant pivoting of the primary lever arm 200 about the pivot point 210. Equally, when the ambient air pressure is minimally greater than the pressure in the internal cavity 103, the diaphragm 102 will flex inwards minimally, causing a minimal pivoting of the primary lever arm 200 about the pivot point 210. The primary lever arm 200 can be biased (for example, by the valve 300) to pivot clockwise when the foot 201 is not in contact with the diaphragm 102. Therefore, when the diaphragm 102 flexes outwards after having flexed inwards and caused the primary lever arm 200 to pivot anticlockwise, the biasing will pivot the primary lever arm 200 clockwise until the foot 201 returns to contacting the diaphragm 102.

When the regulator 100 is connected to the mask 18, the internal cavity 103 of the regulator 100 is in fluid communication with the inside of the mask 18. Therefore, when a user is wearing the mask 18, the act of the user inhaling causes a decrease in the pressure in the internal cavity 103. This decrease in pressure in the internal cavity 103 causes the diaphragm 102 moves inwards, causing the primary lever arm 200 to pivot. The pivoting of the primary lever arm 200 causes the valve 300 to open, resulting in breathing gas being introduced into the internal cavity 103 for the user to inhale. As the breathing gas is introduced, the pressure in the internal cavity 103 increases and eventually causes the diaphragm 102 to flex outwards, allowing the primary lever arm 200 to pivot back to its original position due to the biasing of the primary lever arm 200.

Each breath a user takes will generally be of a similar volume. Thus, the extent to which the diaphragm 102 flexes inwards when the user inhales will generally depend on the ambient pressure (which is usually relatively constant) and the pressure of the breathing gas introduced into the internal cavity 103. The breathing gas introduced may generally be at a pressure of between 140 kPa and 900 kPa. When the input breathing gas is at a higher pressure, for instance between 450 kPa and 900 kPa, the user inhaling will cause less significant inward flexing of the diaphragm 102 than when the input breathing gas is at a lower pressure, for instance between 140 kPa and 450 kPa, which causes more significant inward flexing of the diaphragm 102. When the input breathing gas is at a higher pressure and while the user inhales, the pressure difference between the internal cavity 103 and ambient air pressure is lower than when the input breathing gas is at a lower pressure and the user inhales. Therefore, when the input breathing gas is at a higher pressure, the primary lever arm 200 will be pivoted by the flexing of the diaphragm 102 less than when the input breathing gas is at a lower pressure. The extent to which the primary lever arm 200 pivots can therefore be considered to be at least partially inversely correlated with the pressure of the input breathing gas.

As shown in FIG. 3, the primary lever arm 200 comprises a cam element 220 proximal to the pivot point 210. The cam element 220 is formed by a proximal portion of the primary lever arm 200, which in this example is enlarged, and a surface around the proximal portion which is configured to actuate the valve 300 (whether via direct contact or indirectly, e.g., via a linkage) as the primary lever arm 200 pivots.

The primary lever arm 200 can contact the valve 300 directly. In this case, the cam element 220 of the primary lever arm 200 may contact a piston 310 of the valve 300 directly. In such embodiments, as the primary lever arm 200 pivots, the cam element 220 pushes against the piston 310. In this way, the piston 310 acts as a cam follower and moves laterally, causing a valve member 320 to lift off from a seal seat 330, allowing pressurised breathing gas to flow past the valve member 320 and into the internal cavity 103. In other embodiments, including the embodiment shown in FIG. 3, the primary lever arm 200 may indirectly engage the piston 310 of the valve 300. In this case, a secondary lever arm 400 may be provided to form a linkage between the cam element 220 of the primary lever arm 200 and the piston 310. The secondary lever arm 400 may comprise a secondary pivot point 410, about which the secondary lever arm 400 can pivot. The secondary pivot point 410 may be arranged offset from the pivot point 210 of the primary lever arm 200. As is the case with the embodiment shown, the secondary lever arm 400 may be configured to pivot in the opposite direction to the direction of pivoting of the primary lever arm 200. In this way, as the primary lever arm 200 pivots anticlockwise, the cam element 220 may contact the secondary lever arm 400 and cause the secondary lever arm 400 to pivot clockwise. In some embodiments, the secondary lever arm 400 is an adjustable lever arm 400. In the embodiment shown, for instance, the secondary lever arm 400 includes a setting screw 420 which can be adjusted to vary an effective thickness of the secondary lever arm 400. Adjusting the effective thickness of the adjustable lever arm applies a “displacement offset” to a displacement conveyed from the cam element 220 of the primary lever arm 200 to the piston 310. Therefore, in this way the secondary lever arm 400 can be used to alter the angle at which the primary lever arm 200 must be pivoted to in order to cause the valve member 320 to lift off from the seal seat 330.

The valve 300 may also comprise a biasing element 340 such as a spring. The biasing element 340 biases the valve member 320 to return to the seal seat 330 once the dynamic pressure of the breathing gas moving through the valve 300 (relative to the internal cavity 103 pressure) is no longer sufficient to hold the valve 300 open. In doing so, the biasing also causes the primary lever arm 200 to pivot clockwise around the pivot point 210.

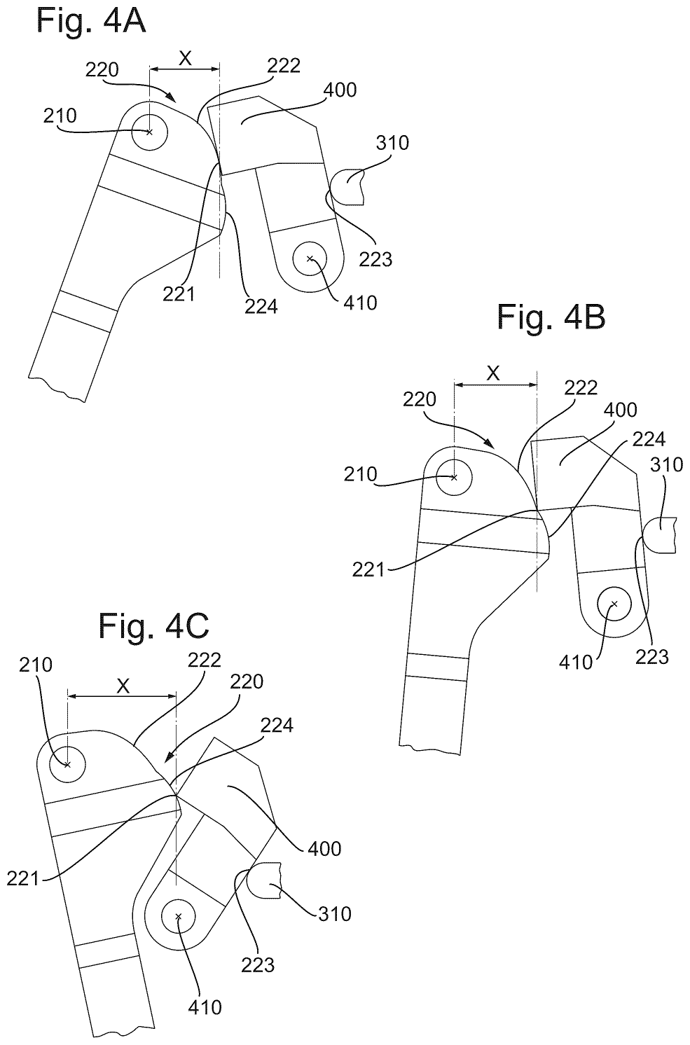

Turning now to FIGS. 4A-4C, the cam element 220 of the primary lever arm 200, the secondary lever arm 400, and the piston 310 are shown in isolation and in more detail for ease of understanding. As shown, the cam element 220 comprises a first profile 222 and a second profile 224. The arrow marked X represents a displacement of the secondary lever arm 400 relative to the pivot point 210. The cam element engagement point 221 represents the location where the cam element 220 engages (in this case, meaning contacts) with the secondary lever arm 400. The plunger engagement point 223 represents the location where the secondary lever arm 400 engages (in this case, meaning contacts) the piston 310. The cam element engagement point 221, the plunger engagement point 223, and the first and second profiles 222, 224, therefore defines the extent to which the valve 300 is actuated. Notably, throughout the full pivoting range of the primary lever arm 200, the cam element engagement point 221 moves further from the pivot point 210 (denoted by the arrow X which increase in length moving through each of FIG. 4A-4C). As a result, the pivoting of the primary lever arm 200 through its full range of motion causes an ever increasing rotation of the secondary lever arm 400 and thus an ever increasing displacement of the valve 300 via the piston 310.

It will be appreciated that in some embodiments where the piston 310 directly contacts the cam element 220, the cam element engagement point 221 and the plunger engagement point 223 may be the same point on the cam element 220.

As the primary lever arm 200 pivots about the pivot point 210, the cam element 220 contacts the secondary lever arm 400 which pushes on the piston 310 which causes the valve 300 to open. FIG. 4A shows the primary lever arm 200 in an initial position, corresponding to an unflexed position of the diaphragm 102. Initially, the first profile 222 of the cam element 220 is in contact with the secondary lever arm 400 (demonstrate by the position of the cam element engagement point 221). As the primary lever arm 200 is pivoted (shown in FIG. 4B) due to inward flexing of the diaphragm 102, the cam element engagement point 221 moves along the first profile 222. During this pivoting, the shape of the first profile 222 determines the rate (relative to the rate of pivoting of the primary lever arm 200) at which the secondary lever arm 400 is pivoted and thus the rate at which the piston 310 is displaced. Thus, the shape of the first profile 222 determines the rate at which the valve member 320 is displaced from the seal seat 330. The positions through which the primary lever arm 200 is pivotable while cam element engagement point is on first profile 222 can be considered to form a “first arc”. In other words, pivoting the primary lever arm 200 through this first arc, which corresponds to the first profile 222, causes the valve member 320 to be displaced at a first displacement rate.

As the primary lever arm 200 pivots further (shown in FIG. 4C), the cam element engagement point 221 moves past the first profile 222 and onto the second profile 224. As the cam element engagement point 221 moves along the second profile 224, the second profile 224 determines the rate at which the valve member 320 is displaced from the seal seat 330. The positions through which the primary lever arm 200 is pivotable while the cam element engagement point 221 on the second profile 224 can be considered to form a “second arc”. In other words, pivoting the primary lever arm 200 through this second arc, which corresponds to the second profile 224, causes the valve member 320 to be displaced at a second displacement rate. The first profile 222 is generally different to the second profile 224. Therefore, the first and second displacement rates are generally different. In some embodiments, the second displacement rate is higher than the first displacement rate.

The first arc can be considered to represent a range of angles through which the primary lever arm 200 pivots. Pivoting the primary lever arm 200 through the first arc can therefore be defined as pivoting the primary lever arm 200 between a first rotation angle and a second rotation angle around the pivot point 210. Similarly, the second arc can be considered to represent a range of angles through which the primary lever arm 200 pivots. Pivoting the primary lever arm 200 through the second arc can therefore be defined as pivoting the primary lever arm 200 between a third rotation angle and a fourth rotation angle around the pivot point 210. In some embodiments, the second rotation angle and the third rotation angle are the same, meaning the first profile 222 and second profile 224 meet at a transition point (as will be described in more detail shortly).

As discussed above, when the breathing gas introduced into the internal cavity 103 is at a higher pressure (e.g., above a threshold pressure of between 300 kPa and 600 kPa), the act of the user inhaling causes less pivoting of the primary lever arm 200 than when the breathing gas introduced into the internal cavity 103 is at a lower pressure (e.g., below a threshold pressure of between 300 kPa and 600 kPa). The primary lever arm 200 and cam element 220 are therefore arranged so that the primary lever arm 200 pivots through the first arc (corresponding to the first profile 222) when the input breathing gas is at a pressure of above a threshold (e.g., at least 450 kPa). The primary lever arm 200 and cam element 220 are also therefore arranged so that the primary lever arm 200 pivots past the first arc and through the second arc (corresponding to the second profile 224) when the input breathing gas is at a pressure of below a threshold (e.g., around 450 kPa). In this way, the shape of the first profile 222 controls the introduction of breathing gas when the breathing gas is at a higher pressure and the second profile 224 controls the introduction of breathing gas when the breathing gas is at a lower pressure.

In some embodiments, the first displacement rate and/or the second displacement rate is constant (i.e., linear) across the respective first and/or second profile. In some embodiments, the first displacement rate and/or the second displacement rate varies with the position of the primary lever arm 200.

The pressure (i.e., the threshold pressure) at which the cam element engagement point 221 moves from the first profile 222 to the second profile 224 can be set according to the design requirements and likely use cases of the regulator 100 and breathing apparatus 10. The threshold pressure will generally be slightly below the typical (or expected) pressure of breathing gas available to the regulator 100 when in use. As noted above, the threshold pressure can be between 300 kPa and 600 kPa. In some embodiments, the threshold pressure is around 450 kPa. In this way, when the input breathing gas is at a pressure above 450 kPa, the first profile 222 determines the displacement rate of the valve member 320, and when the input breathing gas is at a pressure below 450 kPa, the second profile determines the displacement rate of the valve member 320.

In some embodiments, the second profile 224 corresponds to a greater displacement rate of the valve member 320 than the first profile 222. In this way, when the input breathing gas is at a lower pressure, valve 300 will be opened further. As the rate of breathing of the user is generally relatively stable between breaths, this further opening of the valve 300 means that the total time the valve 300 is open for is greater. The combination of the valve 300 being open further and for longer allows more breathing gas to enter the internal cavity 103 during each inhalation by the user. This additional breathing gas introduced advantageously prevents any period of time where a negative pressure inside the cavity 103 forms. Therefore, the present disclosure advantageously provides for normal operation of a regulator 100 when the input breathing gas pressure is at an expected value, and prevents potentially harmful contaminants from being drawn into the regulator 100 and/or face mask 18 when the input breathing gas is at a lower than optimal and/or expected pressure. The present disclosure achieves these benefits by automatically adapting the quantity of breathing gas introduced into the regulator 100 according to the pressure of said breathing gas.

In some embodiments, the first profile 222 and/or the second profile 224 are convex on the surface of the cam element 220. In some embodiments, the first profile 222 and/or the second profile 224 are arcuate in shape with first and second radii, respectively. In some embodiments the first and second radii are the same, while the centre of the arc of each profile are offset. In some embodiments, the first and second radii are different and the centre of the arc of each profile are offset. Where the first and second radii are different, the first radius may be smaller than the second radius. Where the centres of each arc are offset, the centre of the first arc may be radially closer to the pivot point 210 than the centre of the second arc.

In some embodiments, the first and second profiles 222, 224 meet on the surface of the cam element 220 at a continuous transition point. In some embodiments, the first and second profiles 222, 224 meet on the surface of the cam element 220 at a discontinuous transition point. A continuous transition point is a point where a tangent of the first profile 222 at an end point of the first profile 222 is collinear with a tangent of the second profile 224 at a start point of the second profile 224. A discontinuous transition point is a point where a tangent of the first profile 222 at an end point of the first profile 222 is noncollinear with (but may intersect) a tangent of the second profile at a start point of the second profile 224.

While the present disclosure is applicable to regulators 100 and breathing apparatus 10 as discussed, the disclosure also lies in the primary lever arm 200 itself. It will be appreciated that a primary lever arm 200 comprising a cam element with first and second profiles 222, 224 is applicable to many different types of regulator 100 and the application of the primary lever arm 200 in such regulators enables the benefits of the present disclosure to be derived therefrom.

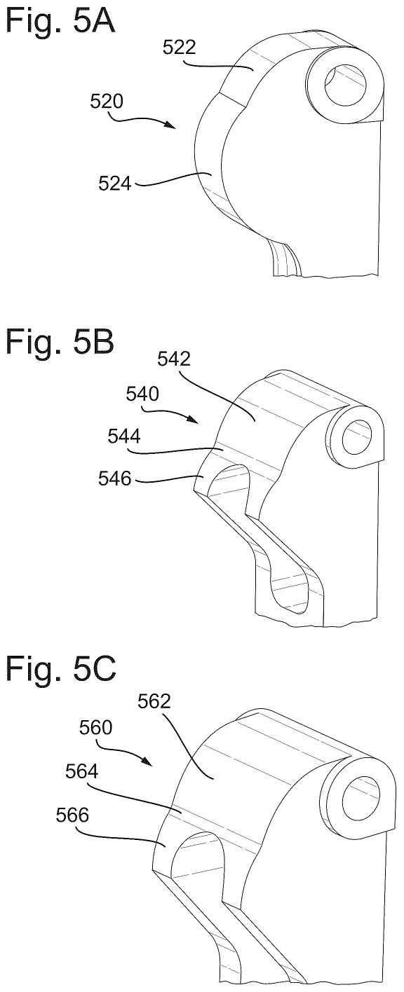

FIGS. 5A-C show additional embodiments of primary lever arms. FIG. 5A shows a primary lever arm comprising a cam element 520 which has first and second profiles 522, 524 similar to the first and second profiles 222, 224 discussed above but with different shapes. The different shapes of first and second profiles 522, 524 contribute to different displacement rates of valve members for other applicable regulators (not shown).

FIG. 5B shows a further embodiment of a cam element 540, again comprising first and second profiles 542, 544. The cam element 540 of this embodiment also includes a third profile 546. This third profile 546 provides a different displacement rate to both the first and second profiles 542, 544. In some embodiments, such third profiles 546 may provide further increased displacement rates, greater than the displacement rates provided by both the first and second profiles 542, 544. Embodiments comprising cam element with more than two profiles may be employed to further increase the flow of breathing gas into a regulator when the pressure of the breathing gas is particularly low.

FIG. 5C shows an additional embodiment of a cam element 560, similar to the embodiment shown in FIG. 5B. This cam element 560 has first, second, and third profiles 562, 564, 566 with different shapes to the first, second, and third profiles 542, 544, 546 of the cam element 540 described above. Notably, the third profile 566 of this cam element 560 is arcuate with a larger radius than the radius of the arcuate third profile 546 of the previous cam element 540.

It will be appreciated that many different shapes and designs of cam element are applicable to primary lever arms according to the present disclosure. The shape of the cam element may be determined according to the intendent application (e.g., expected operating pressure) of each type of regulator.

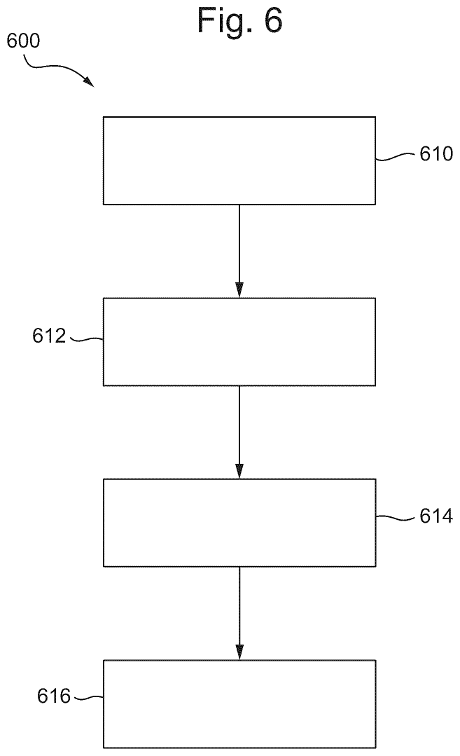

Turning to FIG. 6, a block diagram of a method 600 according to an embodiment of the present disclosure is shown. The method 600 may be a computer-implemented method, wherein the steps of the method 600 are executed by a processor of a computer. The methods described herein generally relate to designing a cam element profile for a lever arm of a regulator. The lever arm may be a primary lever arm as described above. As described above, the regulator will generally comprise a valve member. The cam element profile is configured to displace the valve member. According to the embodiment of the method shown in FIG. 6, the method starts at step 610 by determining a first peak breathing gas flow rate across a plurality of different valve member displacements at a first breathing gas input pressure, thereby determining a first flow-displacement profile. The first flow-displacement profile can be considered to be a relationship between breathing gas flow rate and valve member displacement. The first flow-displacement profile may be determined analytically and/or empirically.

In some embodiments, the step of determining the first flow-displacement profile comprises first determining a plurality of peak breathing gas flow rates of breathing gas at the first breathing gas input pressure at each of the respective first plurality of different valve member displacements. This data may be represented in a table of data points. The data points may be interpolated to determine a trendline which may be used to determine a flow rate at any given valve member displacement at the given input breathing gas pressure. In some embodiments, the determined trendline is a linear trendline, corresponding to a linear relationship between valve member displacement and peak breathing gas flow rate.

At step 612, a first minimum desired peak flow rate at the first breathing gas input pressure is determined. The first minimum desired peak flow rate represents the minimum peak flow rate that desired (e.g., acceptable) at the given breathing gas input pressure. The peak flow rate must be sufficient to enable an adequate volume of breathing gas (e.g., free air volume) to flow past the valve member, in order to provide an appropriate breathing gas pressure inside the regulator, while the valve is open.

Based upon the first flow-displacement profile, at step 614, a first minimum valve displacement that provides the first minimum desired peak flow rate is determined. As the first flow-displacement profile represents a relationship between flow rate and valve member displacement at the given pressure, the profile can be used to determine a minimum valve member displacement that provides the minimum desired peak flow rate.

At step 616, a first cam profile, comprised in the cam element profile, that displaces the valve member to at least the first minimum valve displacement across an entirety of a first pivot arc of the lever arm. One or more parts of the first cam profile may displace the valve member further than the first minimum valve displacement. For example, an end point of the first cam profile may displace the valve member further than a start point of the first cam profile.

The method may be repeated one or more times in an iterative fashion in order to optimise the (e.g., tend towards an ideal) cam element profile design (for the given design parameters). Where the method is repeated, the cam element profile designed in a first iteration of the method can be used to determine the first flow-displacement profile during a second iteration of the method and so on. In this way, the design of the cam element profile may iteratively be improved/optimised. As the first flow-displacement profile is generally specific to each regulator, a regulator including a valve member and a lever arm with a ‘best guess’ cam element profile can be used in a first iteration of the method to provide a starting point for determining the first flow-displacement profile. The lever arm of the regulator can then be modified to comprise the cam element profile determined during the first iteration of the method once the first iteration of the method has been completed. The regulator with the modified lever arm can then be used in a second iteration of the method and so on.

In some embodiments, the method described above comprises determining a second cam profile, comprised in the cam element profile described above. In order to determine said second cam profile, the method may include the step of determining a second peak breathing gas flow rate across the plurality of different valve member displacements at a second breathing gas input pressure, thereby determining a second flow-displacement profile, similar to how the first flow-displacement profile is determined. The method may then continue with the step of determining a second minimum desired peak flow rate at the second breathing gas input pressure. Once the second minimum desired peak flow rate has been determined, a second minimum valve displacement that provides the second minimum desired peak flow rate may be determined based upon the second flow-displacement profile. The second cam profile that displaces the valve member to at least the second minimum valve displacement across the entirety of a second pivot arc of the lever arm can then be determined.

In some embodiments, the first and second cam profiles may be arranged consecutively along the cam element profile. The first cam profile may meet the second cam profile at a transition point (e.g., a continuous or discontinuous transition point).

It will be appreciated that the method may further comprise determining one or more further cam profiles comprised in the cam element profile. In particular, the method may comprise determining a third cam profile comprised in the cam element profile. It will be understood that each determined cam profile corresponds to a valve member displacement. Therefore, where embodiments of the present method comprise determining third or further cam profiles, these cam profiles will correspond to third and further valve member displacements.

The method 600 can further comprise, as a subsequent step, manufacturing a lever arm comprising the determined first cam profile. The method 600 can further comprise, as a subsequent step, outputting data comprising a 3D design model, for example a CAD model, or manufacturing model or instructions. Types of manufacturing may include additive or subtractive manufacturing. The 3D design model may comprise data indicating the determined cam element profile or a lever arm comprising the determined cam element profile.

While embodiments of the method described herein have been described with the steps in a particular sequence, it will be appreciated that the steps may be performed in any appropriate sequence bearing in mind the technical content of the steps and any dependence of each step upon other steps.

It will be appreciated by those skilled in the art that although the invention has been described by way of example, with reference to one or more exemplary embodiments, it is not limited to the disclosed examples and alternative embodiments could be constructed without departing from the scope of the invention as defined by the appended claims.

1.-15. (canceled)

16. A demand regulator for a breathing apparatus comprising:
a primary lever arm comprising a cam element having a first profile and a second profile, the primary lever arm being pivotable; and
a valve configured to regulate a flow of breathing gas through the demand regulator, the valve comprising a valve member being displaceable so as to regulate the flow of breathing gas;
wherein the cam element of the primary lever arm is configured to displace the valve member during pivoting of the primary lever arm; and
wherein:
pivoting of the primary lever arm through a first arc corresponding to the first profile of the cam element displaces the valve member at a first displacement rate; and
pivoting of the primary lever arm through a second arc corresponding to the second profile of the cam element displaces the valve member at a second displacement rate; the second displacement rate being different to the first displacement rate.

17. The demand regulator according to claim 16, wherein the second displacement rate is higher than the first displacement rate.

18. The demand regulator according to claim 16, wherein:
pivoting of the primary lever arm through the first arc corresponds to a pivoting of the primary lever arm between a first rotation angle and a second rotation angle of the primary lever arm; and
pivoting of the primary lever arm through the second arc corresponds to a pivoting of the primary lever arm between a third rotation angle and a fourth rotation angle of the primary lever arm.

19. The demand regulator according to claim 16, wherein the primary lever arm is configured to pivot through the first arc when an input breathing gas to the demand regulator is above a threshold pressure, and through the second arc when the input breathing gas to the demand regulator is below the threshold pressure.

20. The demand regulator according to claim 19, wherein the threshold pressure is between 300 kPa and 600 kPa.

21. The demand regulator according to claim 16, wherein the first and second profiles are convex.

22. The demand regulator according to claim 16, wherein the first profile is arcuate with a first radius and the second profile is arcuate with a second radius.

23. The demand regulator according to claim 22, wherein the first radius is different to the second radius.

24. The demand regulator according to claim 16, wherein the first profile and the second profile meet at a transition point.

25. The demand regulator according to claim 24 wherein the transition point is a continuous or discontinuous transition point.

26. The demand regulator according to claim 16, further comprising a secondary lever arm disposed between the cam element and the valve member, the secondary lever arm being configured to transmit movement of the cam element to the valve member.

27. The demand regulator according to claim 26, wherein the secondary lever arm is an adjustable lever arm configured to adjustably vary a proportion of movement transmitted from the cam element to the valve member.

28. The demand regulator of claim 27 wherein the adjustable lever arm comprises a setting screw.

29. The demand regulator according to claim 16, further comprising
a body defining an internal cavity; and
a diaphragm disposed in the body, the diaphragm being in communication with the internal cavity on a first side and being in communication with an ambient environment on a second side;
wherein the primary lever arm is configured to abut the diaphragm, and wherein when a pressure decreases in the internal cavity the diaphragm is urged towards the internal cavity and rotates the primary lever arm.

30. A breathing apparatus comprising a demand regulator according to claim 16.

31. A diaphragm-actuated lever arm for a demand regulator comprising:
a cam element for displacing a valve of the demand regulator, the cam element comprising a first cam profile and a second cam profile; and
a diaphragm contact portion, configured to transfer movement of a diaphragm to the diaphragm-actuated lever arm causing the diaphragm-actuated lever arm to pivot;
wherein:
pivoting of the diaphragm-actuated lever arm through a first arc corresponding to the first cam profile is configured to displace the valve at a first displacement rate; and
pivoting of the diaphragm-actuated lever arm through a second arc corresponding to the second cam profile is configured to displace the valve at a second displacement rate, different to the first displacement rate.

32. A method for designing a cam element profile for a lever arm of a demand regulator, the demand regulator comprising a valve member, the cam element profile being configured to displace the valve member, the method comprising the steps of:
determining a first peak breathing gas flow rate across a plurality of different valve member displacements at a first breathing gas input pressure to determine a first flow-displacement profile;
determining a first minimum desired peak flow rate at the first breathing gas input pressure;
determining a first minimum valve displacement that provides the first minimum desired peak flow rate based upon the first flow-displacement profile; and
determining a first cam profile, comprised in the cam element profile, that displaces the valve member to at least the first minimum valve displacement across an entirety of a first pivot arc of the lever arm.

33. The method according to claim 32, further comprising the steps of:
determining a second peak breathing gas flow rate across the plurality of different valve member displacements at a second breathing gas input pressure, thereby determining a second flow-displacement profile;
determining a second minimum desired peak flow rate at the second breathing gas input pressure;
determining a second minimum valve displacement that provides the second minimum desired peak flow rate based upon the second flow-displacement profile; and
determining a second cam profile, comprised in the cam element profile, that displaces the valve member to at least the second minimum valve displacement across an entirety of a second pivot arc of the lever arm.
